(19) United States
(12) Patent Application Publication
(10) Pub. No.: US 2021/0088074 A1
(43) Pub. Date: Mar. 25, 2021

(54) FASTENER SYSTEM WITH BALL AND SOCKET CONNECTORS

(71) Applicant: Abraham Lamark, Des Moines, IA (US)

(72) Inventor: Abraham Lamark, Des Moines, IA (US)

(21) Appl. No.: 17/247,316

(22) Filed: Dec. 7, 2020

Related U.S. Application Data
(63) Continuation-in-part of application No. 16/169,805, filed on Oct. 24, 2018.
(60) Provisional application No. 62/944,911, filed on Dec. 6, 2019.
(60) Provisional application No. 62/576,475, filed on Oct. 24, 2017.

(51) Int. Cl. F16C 11/06; F16B 5/02

(52) U.S. Cl. CPC F16C 11/0695; F16B 5/02

(57) ABSTRACT

A system for joining together pieces of cardboard is well-suited for use by children as a toy, or for more useful purposes such as joining cardboard to make useful structures such as furniture. The system includes various fasteners, connectors and supports that can be used to join pieces of cardboard without the need for tools such as drills, screwdrivers, wrenches, hammers, or the like. The system permits great flexibility in joining cardboard together such that it might be used to create sculptures or whimsical structures of a user's imagination, recreational structures like play forts or playhouses, or more useful items like furniture. Additional connectors may include ball and socket connectors and an extender that permits use with thicker and more sheets of cardboard.

### CROSS-REFERENCE

This application is a non-provisional claiming priority from U.S. Provisional Application No. 62/944,911 filed Dec. 6, 2019. This application is a continuation-in-part of U.S. patent application Ser. No. 16/169,805 filed Oct. 24, 2018, pending, which claims priority from U.S. Provisional Patent Application Ser. No. 62/576,475, filed Oct. 24, 2017.

### FIELD OF THE INVENTION

The invention relates generally to mechanisms and systems for connecting and attaching elements to form useful or amusing shapes and items.

### BACKGROUND OF THE INVENTION

Children's toys are popular and important, but can be expensive. Furthermore, they can be limited in terms of creativity that they permit. There is always a need for improved and new toys that are economical and teach creativity and dexterity.

### SUMMARY OF THE INVENTION

The present invention is directed to a system for joining together pieces of cardboard. The system is well-suited for use by children as a toy, or for more useful purposes such as joining cardboard to make useful structures such as furniture. The system includes various fasteners, connectors and supports that can be used to join pieces of cardboard without the need for tools such as drills, screwdrivers, wrenches, hammers, or the like. The system permits great flexibility in joining cardboard together such that it might be used to create sculptures or whimsical structures of a user's imagination, recreational structures like play forts or playhouses, or more useful items like furniture.

According to one embodiment, the present invention is directed to a cardboard fastening system that can be used to fasten pieces of cardboard in a variety of configurations. The fastening system could include a variety of fastener mechanisms including a plurality of fastener pins, wherein each of the pins has a head with a top side and an underside, a threaded member extending from a center of the underside of the head and a plurality of cardboard-engagement projections extending from the underside. The system may also include a plurality of fastener bolts and a plurality of corresponding fastener nuts, wherein each of the faster bolts has an upper portion adapted to facilitate a user to apply a torque to the bolt by hand. The system may further include a plurality of starter nuts and a male threaded rod; wherein each of the starter nuts includes a female threaded portion adapted to receive a portion of the male threaded rod, and wherein the male threaded rod is adapted to be cut to desired lengths such that the male threaded member and plurality of starter nuts can be combined to create a plurality of threaded connectors. The system may also include a plurality of angle supports adapted to connect two pieces of cardboard to form an angle, each of the angle supports comprising two plates joined at an angle, each of the plates including an angle plate opening for receiving one of the fastener pins, fastener bolts or threaded connectors. Additionally, the system may have a plurality of flat connectors adapted to connect two pieces of cardboard in a generally planar relationship, each of the flat connectors having at least one flat plate with a plurality of flat plate openings for receiving one of the fastener pins, fastener bolts or threaded connectors. The system could also include a plurality of flex connectors adapted to connect two pieces of cardboard such that the two pieces can flex relative to each other, wherein each of the flex connectors has a pair of flat rigid members attached by a flexible joint, each of the rigid members including a plurality of openings for receiving one of the fastener pins, fastener bolts or threaded connectors.

According to another embodiment, the invention is a connecting system including a plurality of connectors and that can be joined together to form three dimensional forms. The system includes base connectors adapted to be removably connected to a flat surface by magnets or suction cups, intermediate connectors that include ball and or socket connectors and structural connectors adapted to look like real life items such as insect wings, animal limbs or other items. The system can be used to create three-dimensional structures that connect to a flat surface. The system may also include cardboard connectors.

These and/or other objects, features, and advantages of the invention will be apparent to those skilled in the art. The invention is not to be limited to or by these objects, features and advantages. No single embodiment need provide each and every object, feature, or advantage.

### BRIEF DESCRIPTION OF THE DRAWINGS

FIG. 1 is an isometric view of a flat connector according to one embodiment of the present invention.

FIG. 2 is an isometric view of a smaller connector according to one embodiment of the present invention.

FIG. 3 shows an angle connector according to one embodiment of the present invention.

FIG. 4 is an isometric view of a connector used to connect cardboard pieces in a stacked angled relation to each other.

FIG. 5A is an isometric view of a domed threaded connector according to one embodiment of the present invention.

FIG. 5B is a front elevation view of the domed threaded connector of FIG. 5A.

FIG. 6 is an isometric view of a smaller domed threaded connector according to one embodiment of the present invention.

FIG. 7A is a front elevation view of a wing bolt according to one embodiment of the present invention.

FIG. 7B is an isometric view of the wing bolt of FIG. 7B.

FIG. 8A is a front elevation view of a smaller wing bolt according to one embodiment of the present invention.

FIG. 8B is an is an isometric view of the smaller wing bolt of FIG. 8A.

FIGS. 9A and 9B are isometric views of a wing nut according to one embodiment of the present invention.

FIGS. 10A and 10B are isometric views of a smaller wing nut according to one embodiment of the present invention.

FIG. 11 is an isometric view of a threaded stock according to one embodiment of the present invention.

FIG. 12A is an isometric view of a bolt base according to one embodiment of the present invention.

FIG. 12B is a cross-sectional elevation view of the bolt base of FIG. 12B.

FIG. 13A is a top plan view flat cardboard combination joined with flat connectors according to one embodiment of the present invention.

FIG. 13B is a left-side elevation view of the flat cardboard combination of FIG. 13A.

FIG. 14 is an elevation view of a corner cardboard combination joined with an angle connector according to one embodiment of the present invention.

FIG. 15 is an elevation view of a 3-ply cardboard combination joined with domed connectors and wing nuts according to one embodiment of the present invention.

FIG. 16 shows an angle connector according to one embodiment of the present invention.

FIG. 17 shows an isometric view of a flat connector with a ball connector according to one embodiment of the present invention.

FIG. 18 shows a front elevation view of flat connector of FIG. 17.

FIG. 19 shows an isometric view of a flat connector with a socket connector according to one embodiment of the present invention.

FIG. 20 shows a front elevation view of the flat connector of FIG. 19.

FIG. 21 shows a front elevation view of a wing nut with a ball connector.

FIG. 22 shows an isometric view from generally below the wing nut with ball connector of FIG. 21.

FIG. 23 shows an isometric view from generally above the wing nut with ball connector of FIG. 21.

FIG. 24 shows a front elevation view of a wing nut with a socket connector.

FIG. 25 shows an isometric view from generally below the wing nut with socket connector of FIG. 24.

FIG. 26 shows an isometric view from generally above the wing nut with socket connector of FIG. 24.

FIG. 27 shows a front elevation view of a self-tapping extender bolt according to one embodiment of the present invention.

FIG. 28 is an isometric view from generally below the self-tapping extender bolt of FIG. 27.

FIG. 29 is a cross-sectional view showing a portion of a male bolt being received within the female portion of the self-tapping extending bolt of FIG. 27.

FIG. 30 shows a plurality of connectors that can be used to create three-dimensional structures that can be supported on a flat surface, including a vertical surface according to one embodiment of the present invention.

FIG. 31 shows suction cup base connectors and magnetic base connectors from the system of FIG. 30 attached to a flat vertical surface according to one embodiment of the present invention.

FIG. 32 shows the intermediate ball and socket connectors connected to the base connectors of FIG. 31.

FIG. 33 shows a three-dimensional structure on a vertical surface formed from the system of FIG. 30, including a butterfly wing connector.

FIG. 34 shows a three-dimensional structure on a vertical surface formed from the system of FIG. 30 including butterfly wing connectors and a cardboard box.

### DETAILED DESCRIPTION

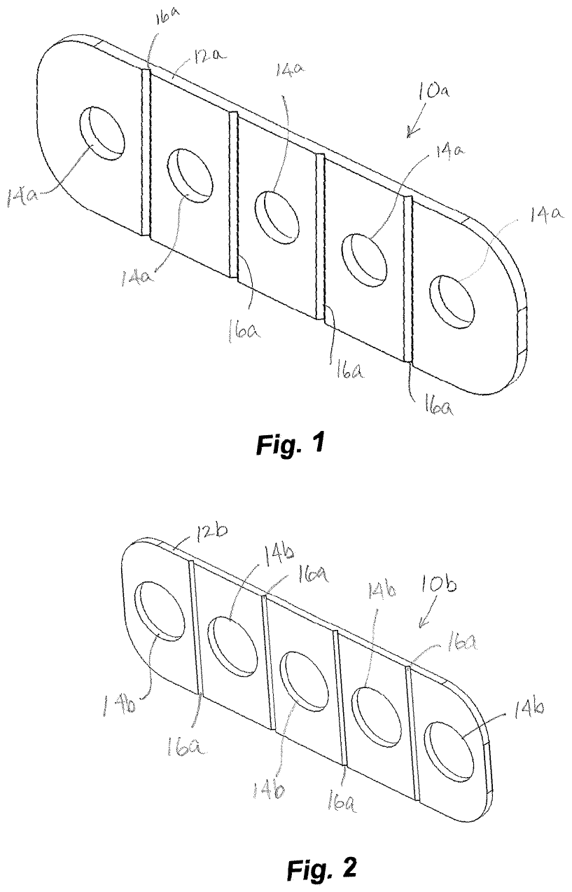

FIG. 1 shows a flat connector 10a for connecting two pieces of cardboard in a planar relation to each other (see FIGS. 13A & B). It includes several holes 14a. Each of the holes 14a is provided in its own section divided by grooves 16a. The plurality of holes 14a permits a user to connect pieces of cardboard at various distances from each other. Alternatively, more than one threaded connector (e.g., 40a) can be used in each piece of cardboard to more securely attach the connector 10a. The grooves 16a are thinned areas that permit some flexing or angling of the connector to increase the ways in which it can be used. The flat connector 10a can be formed from relatively rigid plastic, can be used as a flexible joint if made of more flexible material such as rubber. FIG. 2 shows a flat connector 10b that is similar and has like features to fastener 10a, except the sections and overall length of connector 10b is smaller.

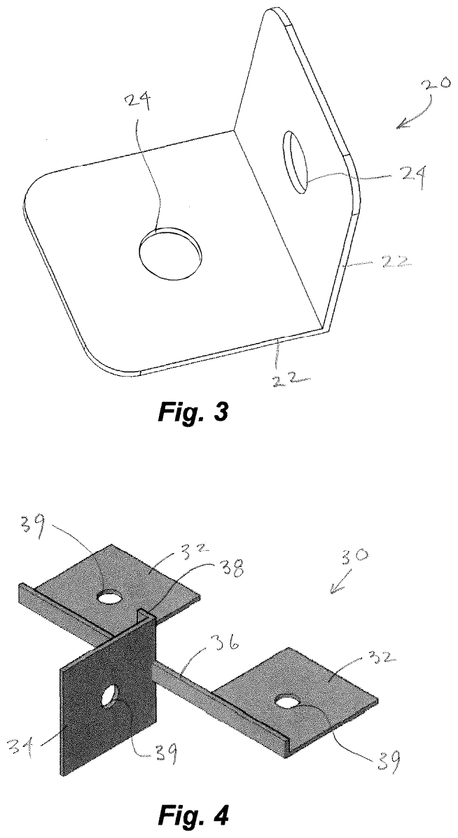

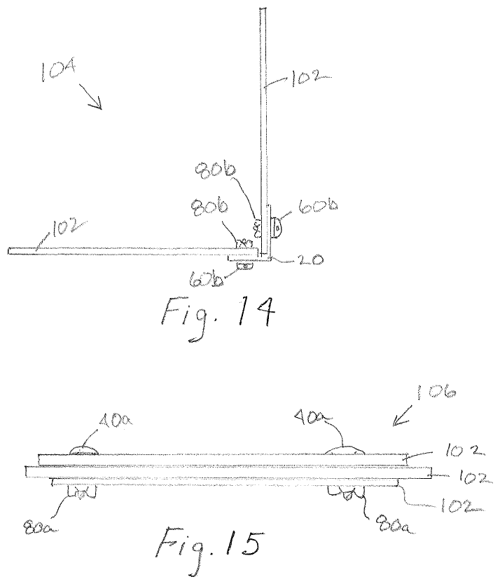

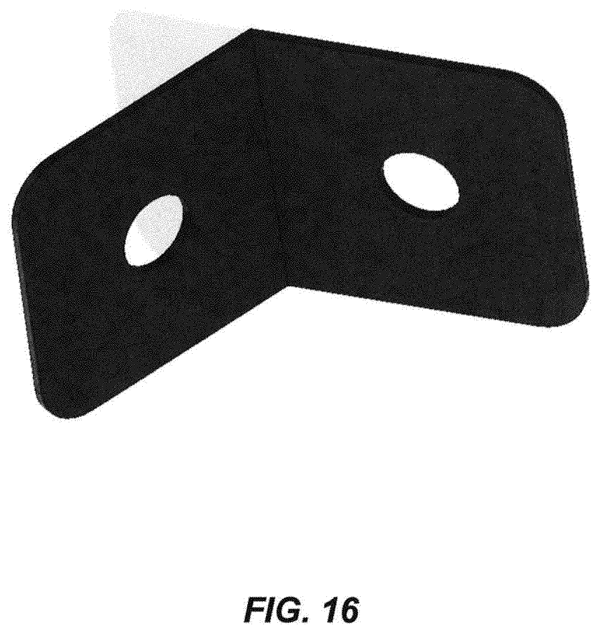

FIG. 3 shows an angle support 20 adapted to connect two pieces of cardboard to form an angle. The angle support 20 comprises two plates 22 joined at an angle, each of the plates 22 includes an angle plate opening 24 for receiving one of the fastener pins 40a, 40b, wing bolts 60a, 60b, or other connector. The angle supports 20 are used to join two pieces of cardboard at an angle to each other (see FIG. 14). In the embodiment shown, the plates 22 are connected to each other at a right angle and are used to join pieces of cardboard together at a right angle. Alternatively, the plates 22 could be joined at any angle to join cardboard at various angles. Cardboard attaches to the angle support by extending a threaded connector through the hole in the plate. While the embodiments shown include only one hole in each plate, it is contemplated that two or more holes may be included in each plate to permit even more secure attachment of the cardboard to the angle support 20.

FIG. 4 shows a connector 30 for connecting two pieces of cardboard in a T-relation to each other. The connector 30 of FIG. 4 includes two square plates 32 connected by a first flange 36 that is generally perpendicular to the plates 32. A second flange 38 is co-planar and transverse to the first flange 36. A third square plate 34 extends from the second flange 38 at a generally right angle relative to the first two plates 32. The flanges 36 and 38 serve as guides that align and help support cardboard that is attached to the plates 32 and 34 via connectors through holes 39. The cardboard pieces can thus be oriented edge-to-edge at a right angle relative to each other.

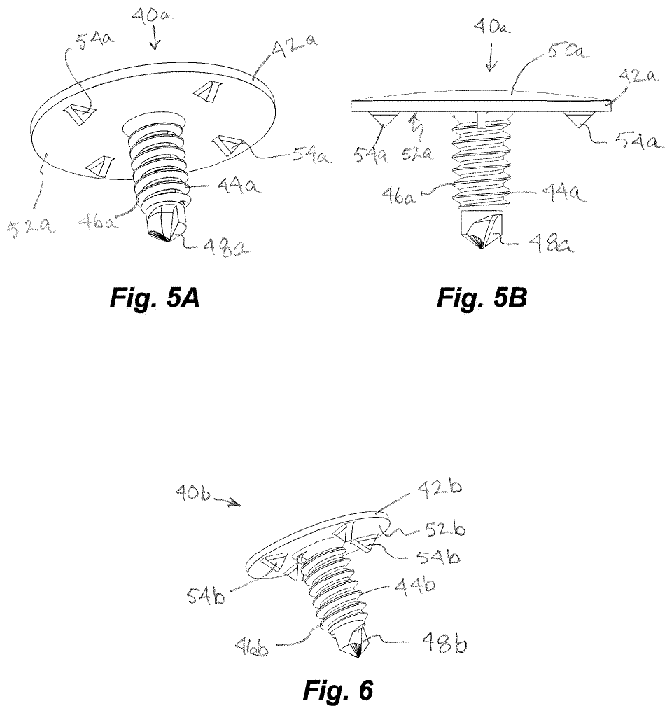

FIGS. 5A and 5B show fastener pin 40a, each of the pins 40a has a head 42a with a domed top side 50a and an underside 52a. A threaded member 44a having threads 46a extends from a center of the underside 52a of the head 42a and a plurality of cardboard-engagement cleats 54a extending from the underside. The fastener pin 40a includes a self-tapping end 48a such that no pilot hole needs to be formed in the cardboard. However, the pin 40a may be used to join pieces where one or more of the pieces has an alignment or pilot hole. The pins 40a may be made from thermoplastic or nylon, or other suitable materials. The pins 40a can be used to join two or more pieces of cardboard without the need for additional hardware such as nuts. Alternatively, the pins 40a may be used with additional hardware such as nuts, supports, hinges, and connectors show herein. The cardboard-engaging cleats 54a act to lock the pin 40a in place when screwed tight against a piece of cardboard. The pins 40a are shown with a rounded smooth head 42a with domed top 50a to present a smooth outer surface when in use. However, it is contemplated that projections may be used on the head to facilitate hand tightening of the pins. Alternatively, a slot or other feature may be included in the head to receive a screwdriver, hex key (e.g., Allen wrench) or the like. FIG. 6 shows a fastener pin 40b that is similar and has like features to fastener pin 40a, except the head 42b is smaller.

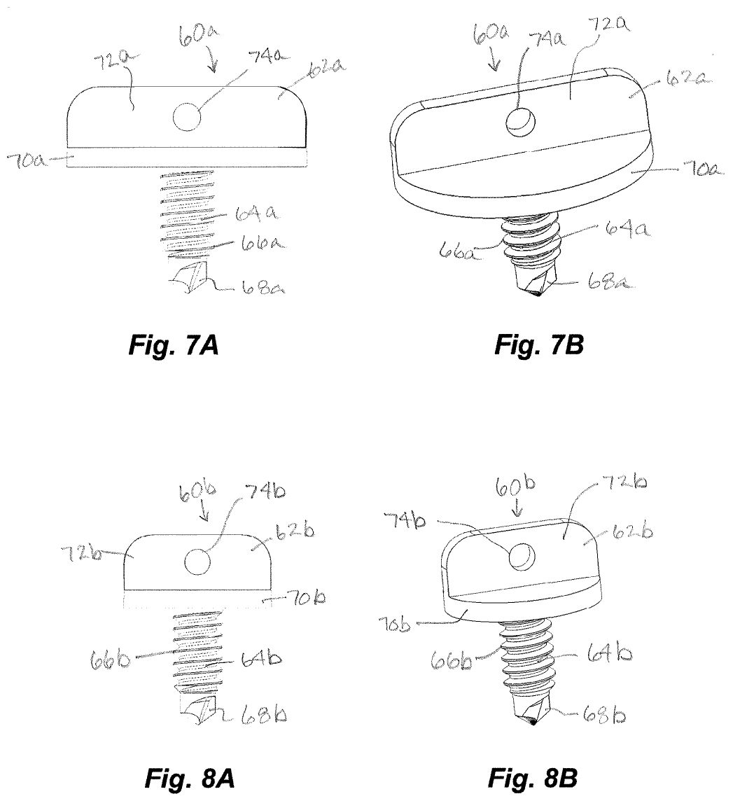

FIGS. 7A and 7B show a wing bolt 60a. The wing bolt 60a has a head 62a and a shaft 64a extending from and under side of the head 62a. The shaft 64a has threads 66a used for engaging a nut and to engage cardboard. The shaft 64a also includes a self-tapping end portion 68a. The head 62a includes a lower cap 70a that acts as a washer and an upwardly extending handle 72a. The handle 72a provides a convenient structure for a user to apply torque by hand without the use of any tools to screw the bolt 60a into cardboard and/or a nut. A hole 74a is provided through the handle 72a. This hole 74a is useful for permitting the wing bolt 60a to be connected to other structures, for example other wing bolts 60a, by string or fishing line, or the like, to make more complicated structures with swinging joints and suspended pieces. FIGS. 8A and 8B show a wing bolt 60b that is similar to wing bolt 60a, but is smaller.

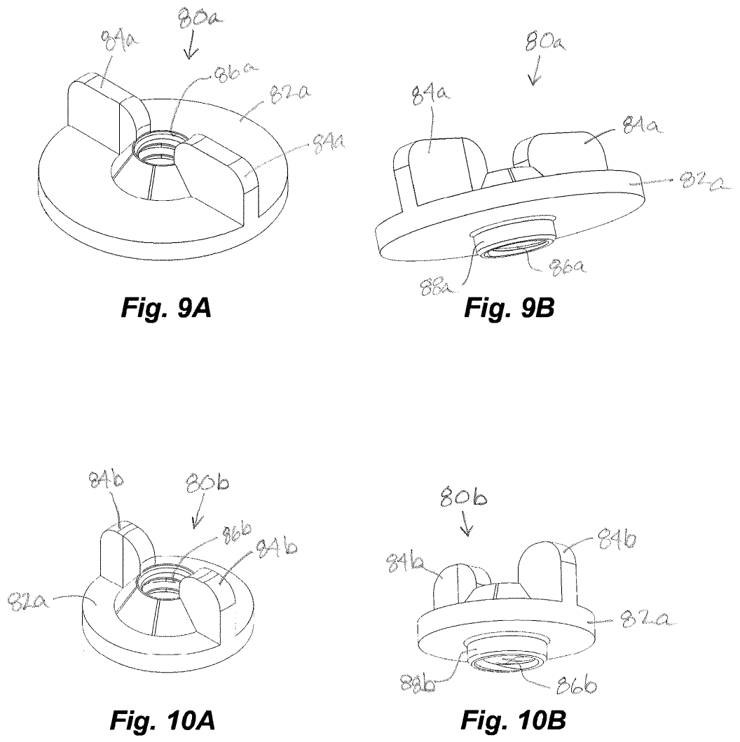

FIGS. 9A and 9B show a wing nut 80a that is adapted for mating connection with wing bolt 60a or fastener pin 40a. The nut 80a includes a lower portion 82a that acts as a washer. Wing handles 84a extend upwardly from the lower portion 82a and serve as handles to aid in applying or resisting torque on nut 80a when mating with a bolt 60a or pin 40a. A threaded passage 86a passes through the center of the lower portion 82a to provide a mating structure for the bolt 60a or pin 40a. A collar 88a extends from the lower surface of the lower portion 82a. An inner surface of the collar 88a forms part of the threaded passage 86a. The collar 88a is intended to friction fit with holes in the cardboard to more securely fix and set the nut 80a in place. FIGS. 10A and 10B show a smaller wingnut 80b that is similar in features to wing nut 80a.

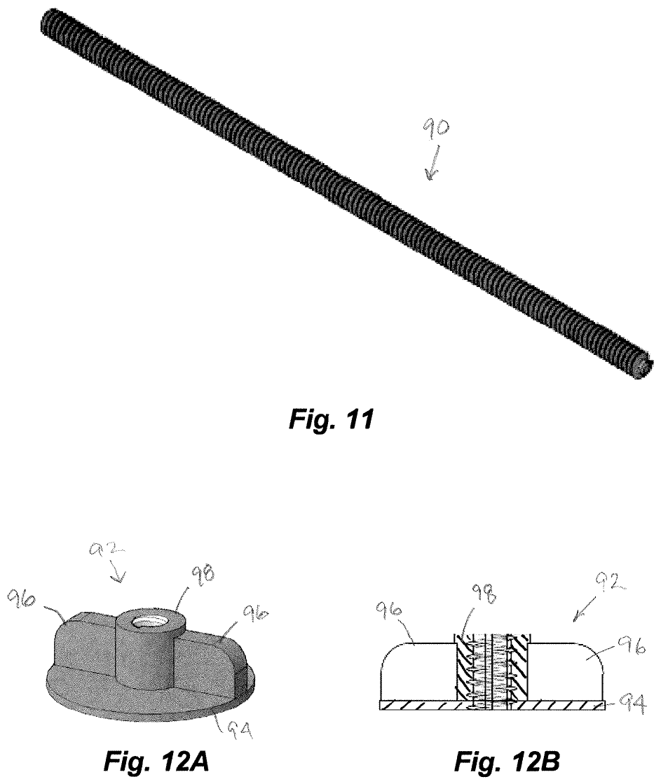

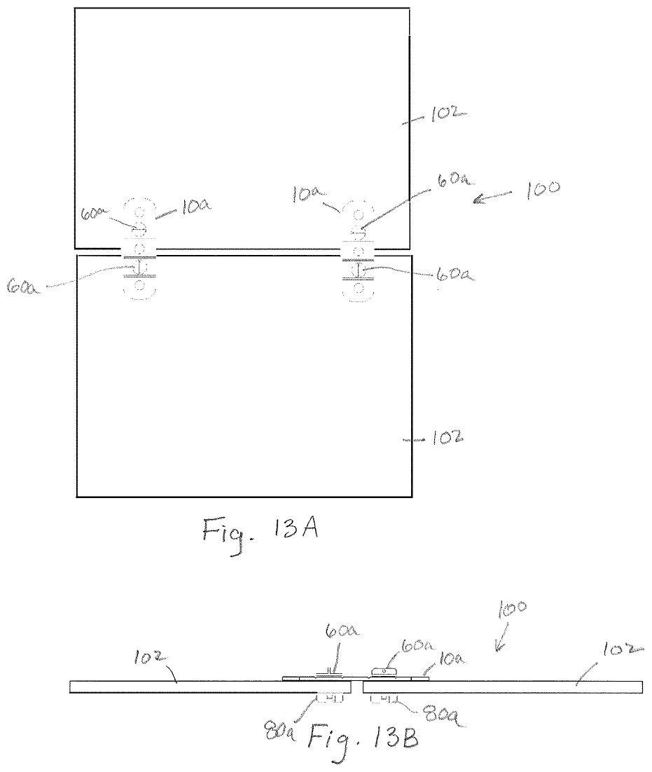

FIGS. 12A and 12B show a starter nut 92 that can be used to make fastener bolts when combined with a length of the all thread 90 shown in FIG. 11. This permits users the flexibility to make fasteners of any desired length by breaking of or cutting the all-thread 90 to a desired length. The all-thread length screws into a pre-threaded opening 98 in the starter nut to combine to form a fastener. The all-thread may be made of sufficient length to join several pieces of cardboard together to create a composite piece that has several layers and greater structural strength.

In use, the fasteners, connectors, and supports can be used to join pieces of cardboard together in a wide variety of configurations. FIGS. 13A&B, 14, and 15 show cardboard structures 100, 104, and 106 created using the fasteners, connectors, and nuts described above to connect pieces of cardboard 102 in various configurations. In many embodiments there is no need for the use of additional tools such as screwdrivers, drills, hammers, or the like. The system permits great flexibility in joining cardboard together to create sculptures or whimsical structures of a user's imagination, recreational structures like play forts or play houses, or more useful items like furniture. In particular, the multi-ply structure 106 of FIG. 15 can be used as building components for strong durable structures.

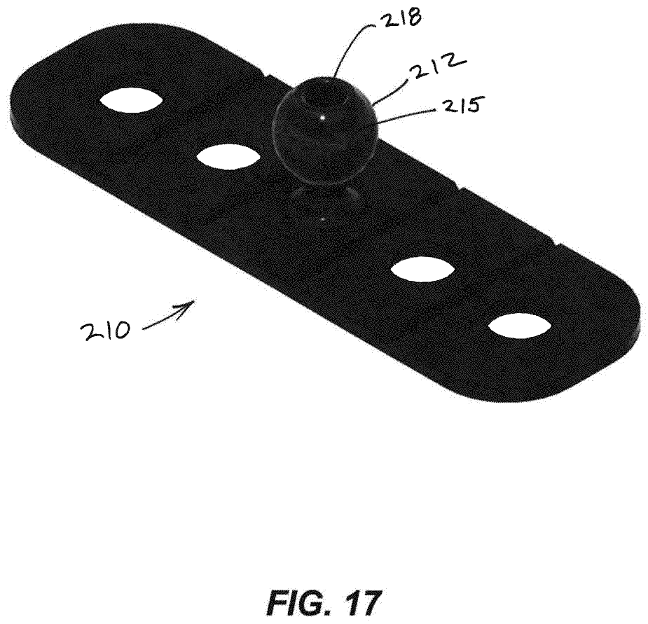

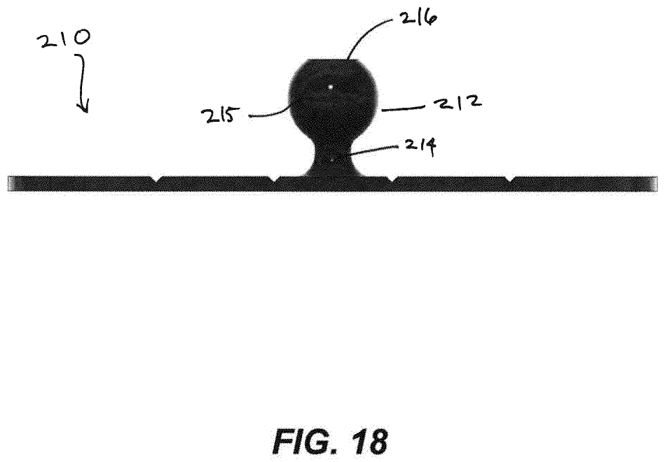

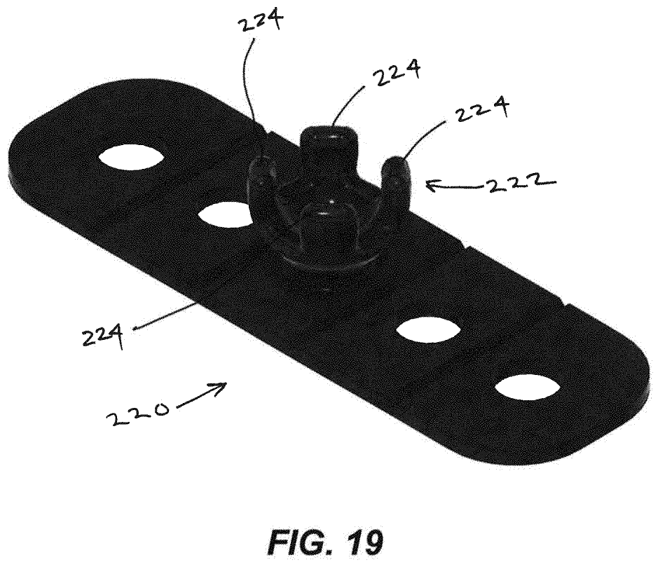

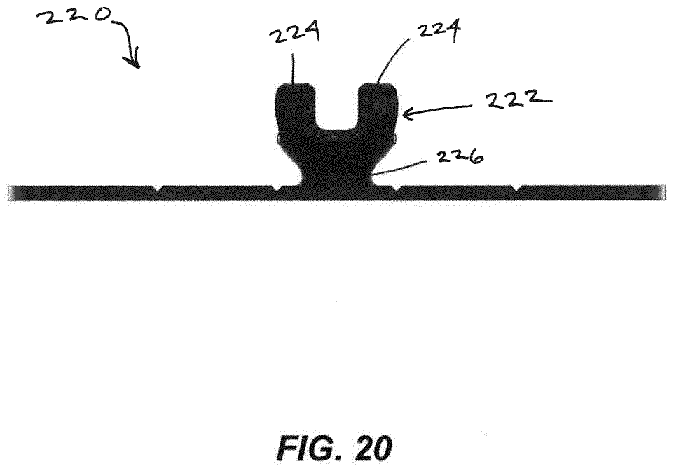

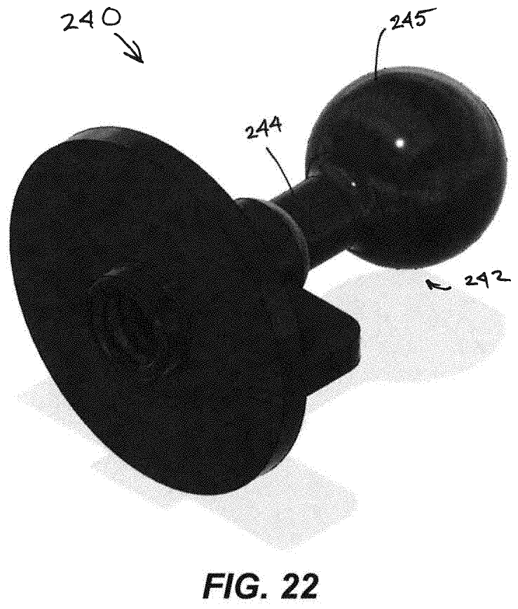

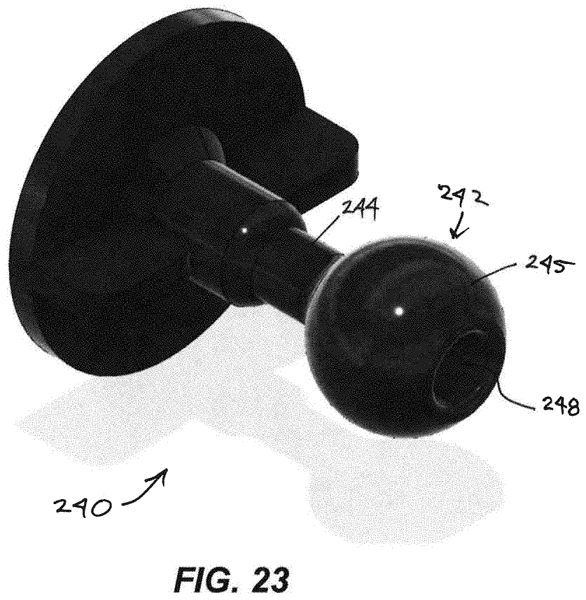

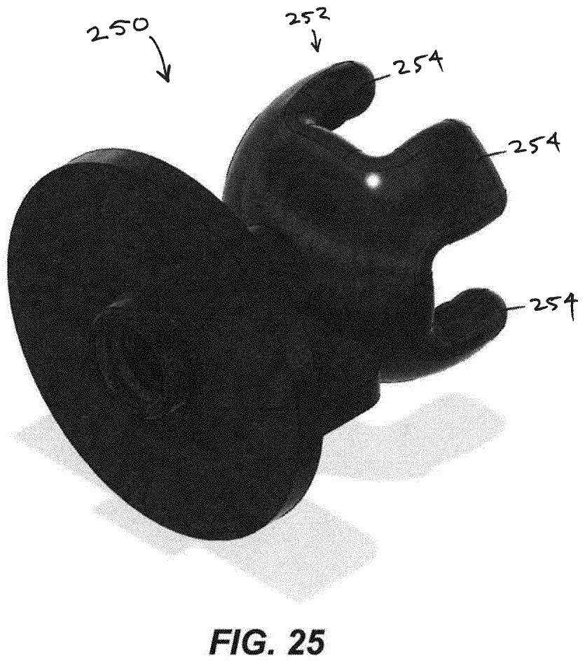

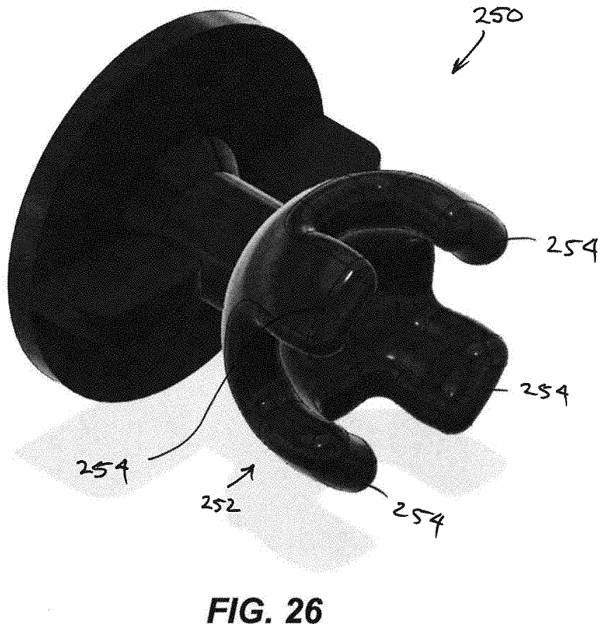

FIGS. 17-26 show additional fasteners and connectors that can be used in association with the above described system to increase the flexibility and uses of the system. FIGS. 17 and 18 illustrate a flat connector with a ball connector 210. The flat connector 210 is similar to connectors 10a and 10b shown in FIGS. 1 and 2, except it also includes a ball joint 212. The ball joint 212 includes a stem 214 and a ball 215. The ball 215 is generally spherical, but may include a flattened upper surface 216. A threaded opening 218 may be provided in the top of the ball 215 to permit connection to a male threaded connector. FIGS. 19 and 20 show a related flat connector with socket joint 220. Flat connector 220 is similar to connectors 10a and 10b shown in FIGS. 1 and 2, except it also includes a socket joint 222. The socket joint 222 is formed to have a friction fit with a ball joint, such as the ball joint 212 in FIGS. 17 and 18. The socket joint 222 may include four (or more or fewer) prongs 224 that extend upward from stem 226.

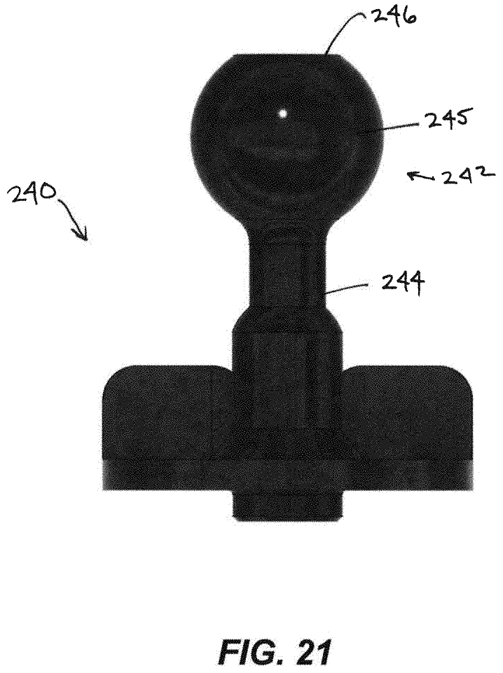

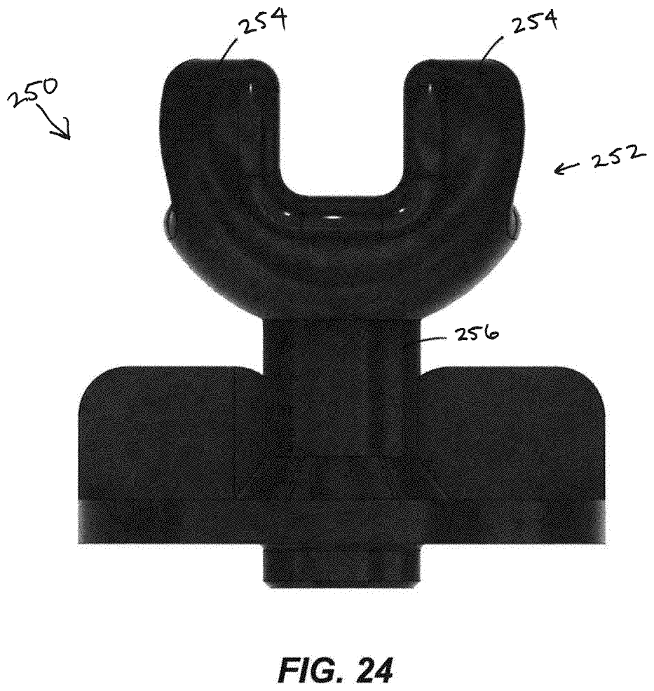

FIGS. 21-23 show a wing nut with ball joint 240. The wing nut 240 is similar to the wing nuts 80a and 80b shown in FIGS. 9A&B and 10A&B, except it includes a ball joint 242. The ball joint 242 includes a stem 244 and a ball 245. The ball 245 is generally spherical, but may include a flattened upper surface 246. A threaded opening 248 may be provided in the top of the ball 215 to permit connection to a male threaded connector. FIGS. 24-26 show a related wing nut with socket joint 250. Wing nut 250 is similar to wing nut 240 shown in FIGS. 21-23 except it also includes a socket joint 252. The socket joint 252 is formed to have a friction fit with a ball joint, such as ball joint 212 in FIGS. 17 and 18 and ball joint 242 in FIGS. 21-23. The socket joint 252 may include four (or more or fewer) prongs 254 that extend upward from stem 256.

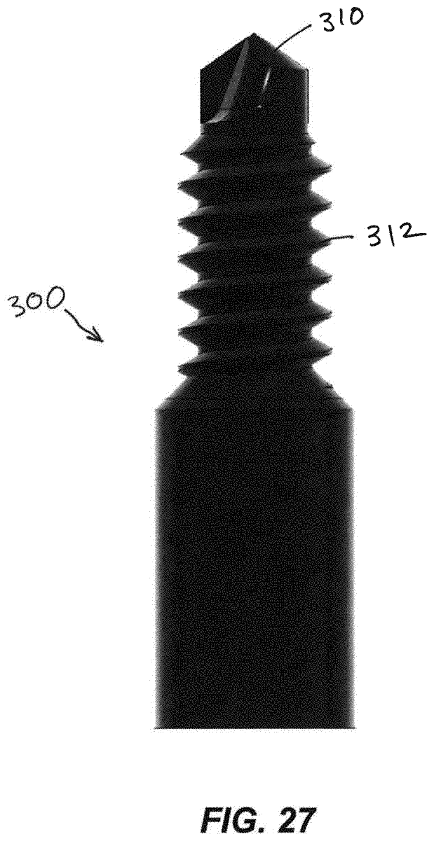

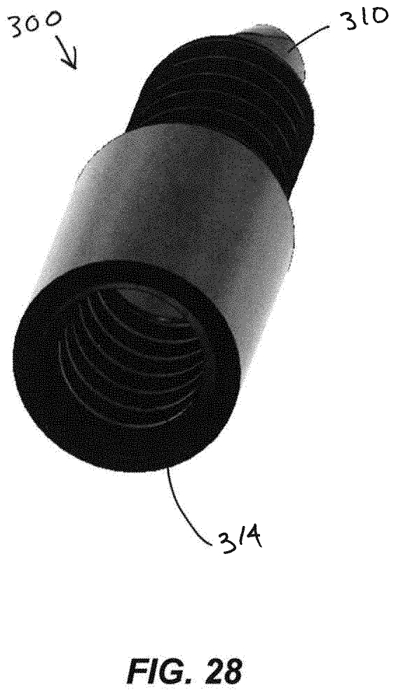

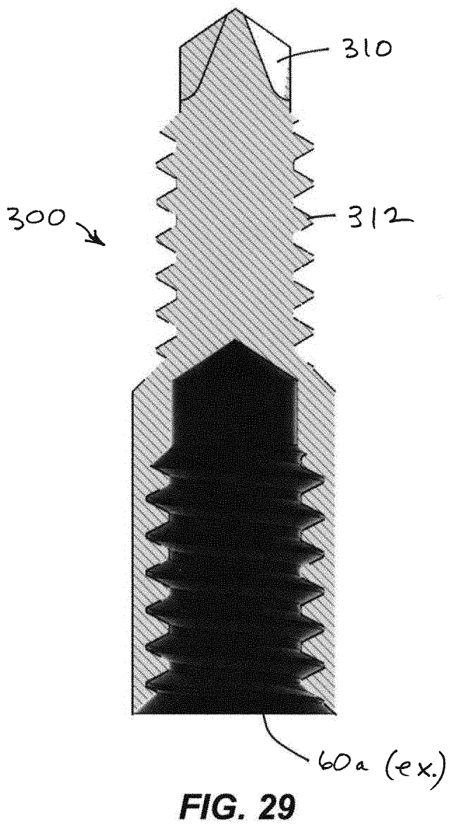

FIGS. 27-29 shows a bolt extender 300. The bolt extender 300 includes a self-tapping point 310, a threaded male shaft 312 and a threaded female receiver 314. The bolt extender 300 is useful for extending male threaded connectors (for example pins 40a, 40b, and wing bolts 60a, 60b). This permits use of the pins 40a, 40b and bolts 60a, 60b with thicker or more layers of cardboard. It should be appreciated that multiple bolt extenders 300 could be used if needed to extend the bolts and pins by any desired amount.

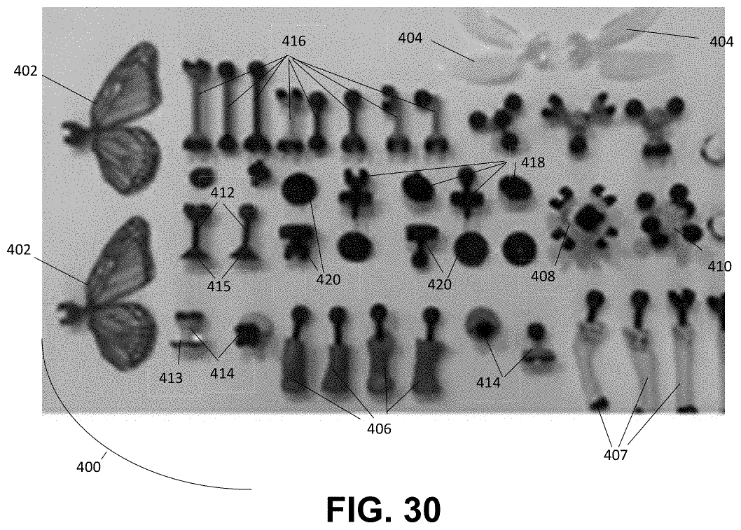

FIG. 30-34 show a system 400 for use in creating three dimensional structures that attached to surfaces with magnets or suction cups. The system 400 includes connectors that utilize ball and socket connectors that are adapted for connection to flat surfaces using suction cups or magnets. The system 400 can be used with the cardboard connectors described and shown herein.

FIG. 30 shows a collection of connectors 400 that can be connected with each other to form an unlimited number of three-dimensional structures. Each of the connectors includes either a ball connector or a socket connector. As an additional feature some of the connectors may include animal parts or other realistic elements that enhances the utility and enjoyment of the system 400. For example, there are butterfly wing connectors 402, dragonfly wing connectors 404, elephant leg connectors 406, and giraffe leg connectors 407. There are six-way connectors 408, 410 that are each include six orthogonally located connections. Connector 408 includes six socket connectors and six-way connector 410 includes six ball connectors. Several base connectors 412, 414 include a magnet 413 or a suction cup 415 at one end and either a ball or socket connector at the opposite end. Intermediate connectors 416 include ball or socket connections on opposite ends. Additionally, self-tapping cardboard base connectors 418 include a threaded portion for rotatable screw-like connection to cardboard and a ball or socket connection opposite from the threaded portion. Nuts 420 are included to more securely fasten the threaded base connectors 418 to cardboard.

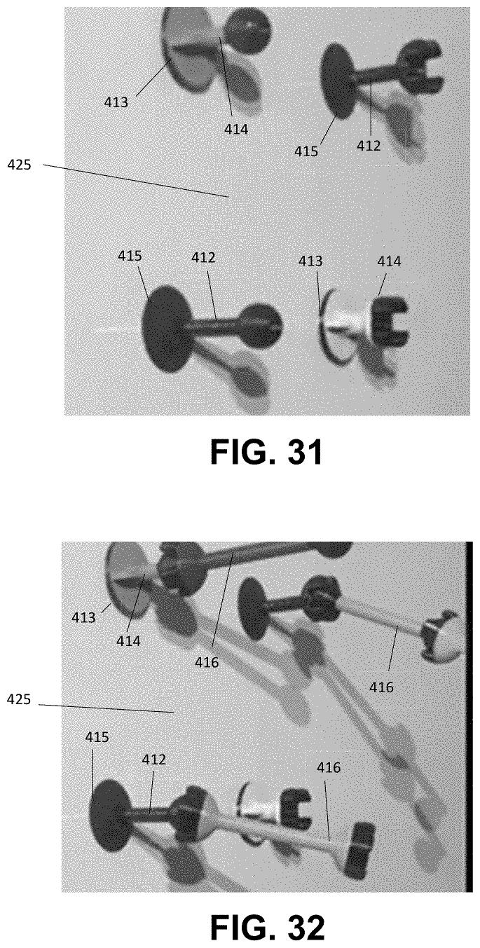

FIG. 31 shows base connectors 412 and 414 attached to a surface 425 (such as a refrigerator door) by either suction cup 415 or magnetic connection 413. FIG. 32 shows intermediate connectors 416 attached to the base connectors of FIG. 31.

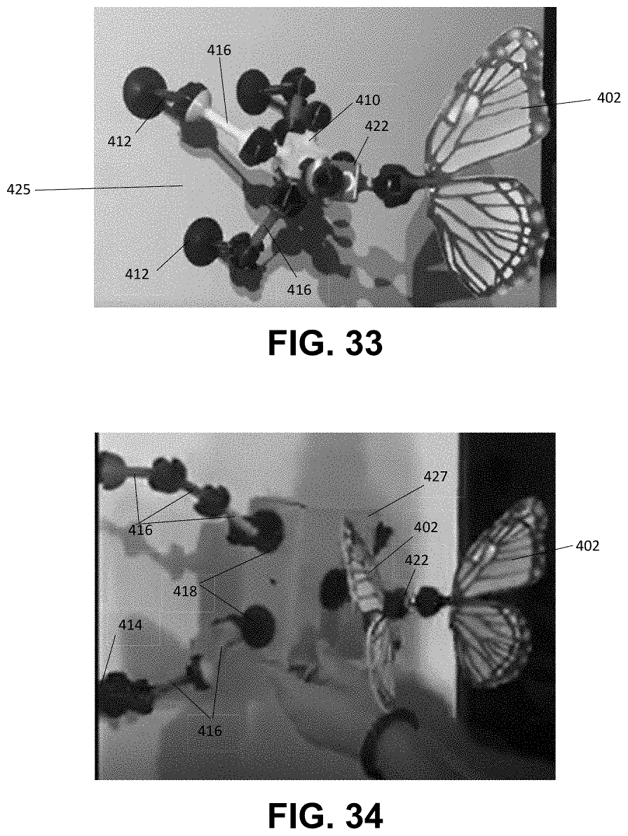

FIG. 33 shows a three-dimensional structure supported on a surface 425 by suction cup base connectors 412. Intermediate connectors 416 attach to a six-way connector 410. A wing connector 422 is used to connect a butterfly wing connector 402.

FIG. 34 shows a three-dimensional structure attached to a surface 425. The structure includes magnetic connectors 414 magnetically attached to the surface 425. Several intermediate connectors 416 are used to form imaginary legs that extend from the magnetic connectors 414 and attach to cardboard connectors 418 that have been attached to a cardboard box 427. Finally, butterfly wing connectors 402 are attached to a wing connector 422 that is in turn connected to another cardboard connector 418.

I claim:

1. A cardboard fastening system comprising:
a plurality of fastener pins, each of the pins having a head with a top side and an underside, a threaded member extending from a center of the underside of the head and a plurality of cardboard-engagement projections extending from the underside;
a plurality of fastener bolts and a plurality of corresponding fastener nuts, wherein each of the faster bolts has an upper portion adapted to facilitate a user to apply a torque to the bolt by hand;
a plurality of starter nuts and a male threaded rod; wherein each of the starter nuts includes a female threaded portion adapted to receive a portion of the male threaded rod, and wherein the male threaded rod is adapted to be cut to desired lengths such that the male threaded member and plurality of starter nuts can be combined to create a plurality of threaded connectors;
a plurality of corner supports adapted to connect three pieces of cardboard to form a corner, each of the corner supports comprising three orthogonal plates, wherein each of the orthogonal plates includes an opening for receiving one of the fastener pins, fastener bolts or threaded connectors;
a plurality of angle supports adapted to connect two pieces of cardboard to form an angle, each of the angle supports comprising two plates joined at an angle, each of the plates including an angle plate opening for receiving one of the fastener pins, fastener bolts or threaded connectors;
a plurality of flat connectors adapted to connect two pieces of cardboard in a generally planar relationship, each of the flat connectors comprising at least one flat plate having a plurality of flat plate openings for receiving one of the fastener pins, fastener bolts or threaded connectors; and
a plurality of flex connectors adapted to connect two pieces of cardboard such that the two pieces can flex relative to each other, each of the flex connectors comprising a pair of flat rigid members attached by a flexible joint, each of the rigid members including a plurality of openings for receiving one of the fastener pins, fastener bolts or threaded connectors.

2. A cardboard connector system comprising flat connector having a flat body and a centrally located ball joint extending from the flat body, the ball joint comprising a stem, and a ball; wherein the ball includes a threaded opening.

3. The cardboard connector system of claim 2 further comprising a second flat connector having a flat body and a centrally located socket joint extending from the flat body, the socket joint comprising a stem and a plurality of prongs extending from the stem for friction with the ball of the ball joint.

4. The cardboard connector system of claim 3 further comprising a wing nut with a ball joint, the wing nut ball joint comprising a stem and a ball, wherein the ball includes a threaded opening.

5. The cardboard connector system of any of claim 1, further comprising a wing nut with a socket joint, the wing nut socket joint comprising a stem and a plurality of prongs extending from the stem for friction with the ball of one of the ball joints.

6. An extender for use in a carboard connector system, the extender comprising a self-tapping point, a threaded male shaft and a threaded female receiver.
